(19) United States
(12) Patent Application Publication
(10) Pub. No.: US 2017/0164267 A1
(43) Pub. Date: Jun. 8, 2017

(54) APPARATUS TO INHIBIT MISUSE OF AN ELECTRICALLY POWERED DEVICE

(71) Applicants: Szabolcs Marka, New York, NY (US); Imre Bartos, New York, NY (US); Zsuzsanna Marka, New York, NY (US)

(72) Inventors: Szabolcs Marka, New York, NY (US); Imre Bartos, New York, NY (US); Zsuzsanna Marka, New York, NY (US)

(73) Assignee: The Trustees of Columbia University in the City of New York, New York, NY (US)

(21) Appl. No.: 15/367,716

(22) Filed: Dec. 2, 2016

Related U.S. Application Data
(60) Provisional application No. 62/262,735, filed on Dec. 3, 2015.

(51) Int. Cl. H04W 48/04; G01S 19/16; G01S 19/24; H04W 4/02; H04W 52/02

(52) U.S. Cl. CPC H04W 48/04; H04W 4/021; H04W 52/0251; H04W 4/023; G01S 19/24; G01S 19/16

(57) ABSTRACT

A system includes an electrical device comprising a power supply and circuitry and a supplemental device integrated into the electrical device. The supplemental device includes a tracker chip to receive current location data of the electrical device. The supplemental device also includes a switch with one side connected to the power supply and another side connected to the circuitry of the electrical device. The supplemental device also includes a processor and a memory chip including a stored predetermined location of the electrical device. The predetermined location is input in an encrypted format into a secure encoding chip. The processor is configured to receive the current location data from the tracker chip, compare the current location data with the predetermination location, and turn off the switch to disconnect the power supply from the circuitry if the current location data does not correspond to the predetermined location.

### BACKGROUND

Electrical devices are prone to misuses (including theft or change of purpose), including those electrical devices used at fixed predetermined locations. These electrical devices include those used at an indoor predetermined location, such as television sets, or devices inside mines, and those deployed at an outdoor predetermined location, such as solar cells and light barriers. Electrical devices deployed outdoors are more susceptible to theft, as they are more accessible. Although various anti-theft devices have been introduced to prevent theft of electrical devices, they usually merely activate an alarm and/or notify an outside entity of the theft.

### SUMMARY

Techniques are provided for inhibiting misuse of electrical devices, including an apparatus that temporarily or permanently disables use of an electrical device upon removal of the electrical device from a predetermined location.

In a first set of embodiments, an apparatus for inhibiting misuse of an electrical device includes a switch with one side connected to a power supply of the electrical device and another side connected to circuitry of the electrical device. The apparatus also includes a tracker chip to receive current location data of the electrical device. The apparatus also includes a processor and a memory chip including a sequence of instructions and a predetermined location of the electrical device. The apparatus also includes a secure encoding chip, where the predetermined location is input in an encrypted format. The memory chip and the sequences of instructions are configured to, with the processor, cause the processor to receive the current location data from the tracker chip; compare the current location data with the predetermination location; and turn off the switch to disconnect the power supply from the circuitry if the current location data does not correspond to the predetermined location. In some embodiments the instructions and/or locations are also encrypted.

In a second set of embodiments, a system includes an electrical device comprising a power supply and circuitry and a supplemental device integrated into the electrical device for inhibiting misuse of the electrical device. The supplemental device includes a tracker chip to receive current location data of the electrical device. The supplemental device also includes a switch with one side connected to the power supply and another side connected to the circuitry of the electrical device. The supplemental device also includes a processor and a memory chip including a sequence of instructions and a predetermined location of the electrical device. The supplemental device also includes a secure encoding chip, where the predetermined location is input in an encrypted format. The memory chip and the sequence of instructions are configured to, with the processor, cause the processor to receive the current location data from the tracker chip; compare the current location data with the predetermination location; and turn off the switch to disconnect the power supply from the circuitry if the current location data does not correspond to the predetermined location.

Still other aspects, features, and advantages are readily apparent from the following detailed description, simply by illustrating a number of particular embodiments and implementations, including the best mode contemplated for carrying out the invention. Other embodiments are also capable of other and different features and advantages, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

Embodiments are illustrated by way of example, and not by way of limitation, in the figures of the accompanying drawings in which like reference numerals refer to similar elements and in which:

FIG. 1 is a block diagram that illustrates an example of an electrical device and integrated supplemental device positioned at a predetermined location, according to one embodiment;

FIG. 2 is a block diagram that illustrates an example of the electrical device and integrated supplemental device of FIG. 1, according to another embodiment;

FIG. 3A is a block diagram that illustrates a system for generating an optical barrier to pests and integrated supplemental device, according to still another embodiment;

FIG. 3B is a block diagram that illustrates an example optical barrier and integrated supplemental device, according to still another embodiment;

FIG. 3C is a block diagram that illustrates an example optical barrier and integrated supplemental device, according to still another embodiment;

FIG. 4 is a block diagram that illustrates a computer system upon which an embodiment of the invention may be implemented;

FIG. 5 is a block diagram that illustrates a chip set upon which an embodiment of the invention may be implemented; and

FIG. 6 is a block diagram that illustrates components of a mobile terminal for communications that is capable of operating in the system of FIG. 2, according to one embodiment.

### DETAILED DESCRIPTION

A system is described for preventing theft of electrical devices, including an apparatus that disables use of an electrical device upon removal of the electrical device from a predetermined location. In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

Notwithstanding that the numerical ranges and parameters setting forth the broad scope are approximations, the numerical values set forth in specific non-limiting examples are reported as precisely as possible. Any numerical value, however, inherently contains certain errors necessarily resulting from the standard deviation found in their respective testing measurements at the time of this writing. Furthermore, unless otherwise clear from the context, a numerical value presented herein has an implied precision given by the least significant digit. Thus a value 1.1 implies a value from 1.05 to 1.15. The term “about” is used to indicate a broader range centered on the given value, and unless otherwise clear from the context implies a broader range around the least significant digit, such as “about 1.1” implies a range from 1.0 to 1.2. If the least significant digit is unclear, then the term “about” implies a factor of two, e.g., “about X” implies a value in the range from 0.5× to 2×, for example, about 100 implies a value in a range from 50 to 200. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 4.

Some embodiments of the invention are described below in the context of a system for preventing theft of electrical devices deployed outdoors at a predetermined location. However, the invention is not limited to this context and includes movement or unlicensed use or other preventable misuse that involves physical movement of the electrical device. In other embodiments, a system is provided for inhibiting misuses of electrical devices used indoors at a predetermined location, such as inhibiting theft a television or a computer or sale of a donated device such as a solar cell or water purifier or air conditioner.

### 1. Overview

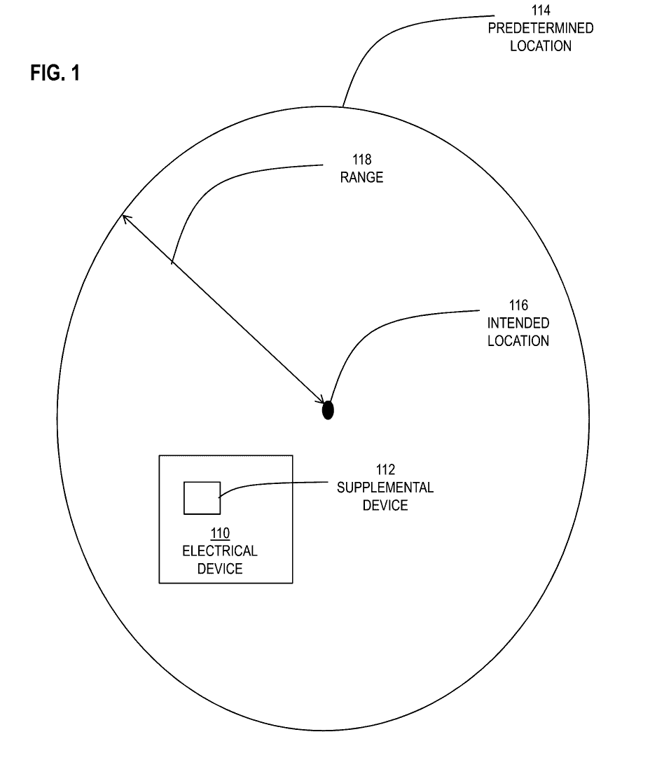

FIG. 1 is a block diagram that illustrates an example of an electrical device 110 and integrated supplemental device 112 positioned at a predetermined location 114, according to one embodiment. In an embodiment, the integrated supplemental device 112 is an unremovable part of the electrical device 110 and cannot be removed without destroying the operability of the electrical device 110. In an embodiment, the integrated supplemental device 112 cannot be bypassed or hacked. In an example embodiment, the integrated supplemental device 112 cannot be bypassed, since it is physically attached, glued, welded or included in the electrical device 110 and thus its removal would physically destroy critical parts of the electrical device 110. Additionally or alternatively, in an example embodiment, the integrated supplemental device 112 cannot be hacked, since firmware of the integrated supplemental device 112 is unreadable and the integrated supplemental device 112 is inaccessible without cryptographic codes that are themselves inaccessible. The predetermined location 114 is a permitted region of use of the electrical device 110 and includes an intended location 116 and a distance range 118 from the intended location 116. In the event that the electrical device 110 is removed from the predetermined location 114, the supplemental device 112 is configured to disable operation of the electrical device 110.

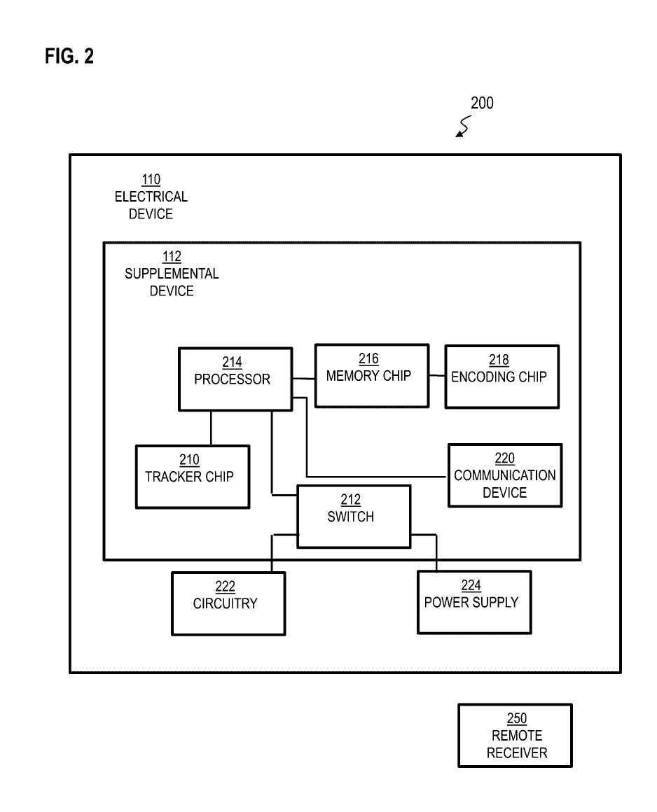

FIG. 2 is a block diagram that illustrates an example of a system 200 including the electrical device 110 and integrated supplemental device 112 of FIG. 1, according to another embodiment. The supplemental device 112 includes a switch 212 with one side connected to a power supply 224 of the electrical device 110 and another side connected to circuitry 222 of the electrical device 110. When the switch 212 is in the “on” position, electrical power is delivered from the power supply 224 to the circuitry 222 of the electrical device 110. When the switch 212 is in the “off” position, electrical power is cut off between the power supply 224 and the circuitry 222 of the electrical device 110, thereby disabling operation of the electrical device 110.

The intended location 116 and distance range 118 of the electrical device 110 are input using a secure encrypted format into an encoding chip 218, after which the intended location 116 and distance range 118 are stored in a memory chip 216. In an embodiment, to modify the stored intended location 116 and distance range 118, a modified intended location 116 and distance range 118 needs to be re-entered into the encoding chip 218 using the secure encrypted format. An example embodiment of the encoding chip 218 is available from Atmel Corporate Headquarters, 1600 Technology Drive, San Jose, Calif. 95110 United States.

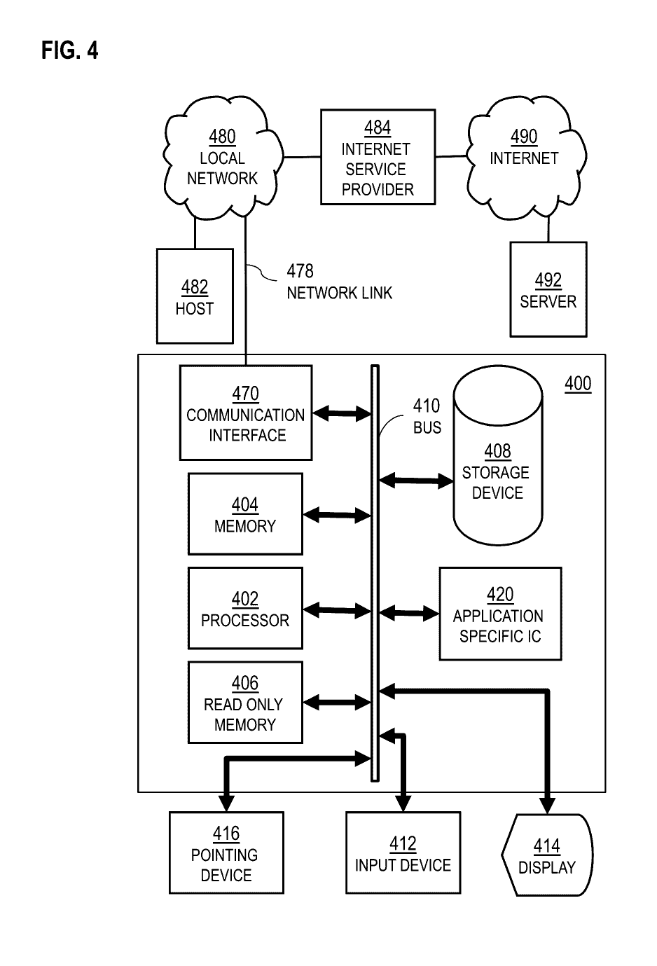

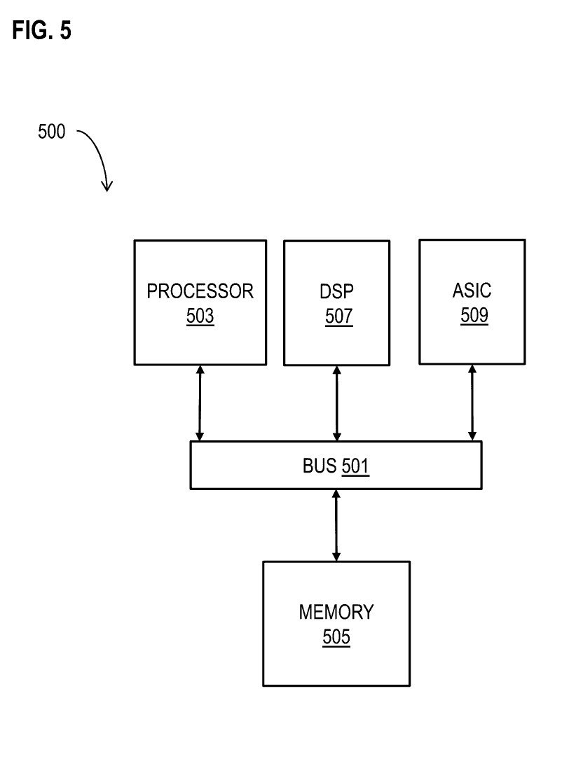

The supplemental device 112 also includes a tracker chip 210 that receives and/or derives current location data indicative of the current location of the electrical device 110. Example components are global positioning system (GPS) chips available from Future Electronics, 1755 North Brown Road, Suite 180, Lawrenceville Ga. 30043, Tel: (678) 407-8060. A processor 214 receives the current location data from the tracker chip 210 and receives the stored intended location 116 and distance range 118 from the memory chip 216. An example embodiment of the processor 214 is SmartMX2 P40 family P400012/040/072 of NXP semiconductor from NXP Semiconductors Netherlands B.V., High Tech Campus 60, 5656 AG Eindhoven, The Netherlands. The processor 214 determines if the electrical device 110 is within the predetermined location 114, based on whether the current location data is within the distance range 118 of the intended location 116. If the processor 214 determines that the electrical device 110 is within the predetermined location 114 (i.e. that the current location data is within the distance range 118 of the intended location 116), the processor 214 takes no action and the switch 212 remains in the “on” position. If the processor 214 determines that the electrical device 110 is outside the predetermined location 114 (i.e. that the current location data is outside the distance range 118 of the intended location 116), the processor 214 transmits a signal to the switch 212, to turn the switch 212 to the “off” position and thus disable the electrical device 110. In various embodiments, the processor 214 comprises one or more general purpose computer systems, as depicted in FIG. 4 or one or more chip sets as depicted in FIG. 5. In some embodiments, the processor is a simple application specific integrated circuit (ASIC).

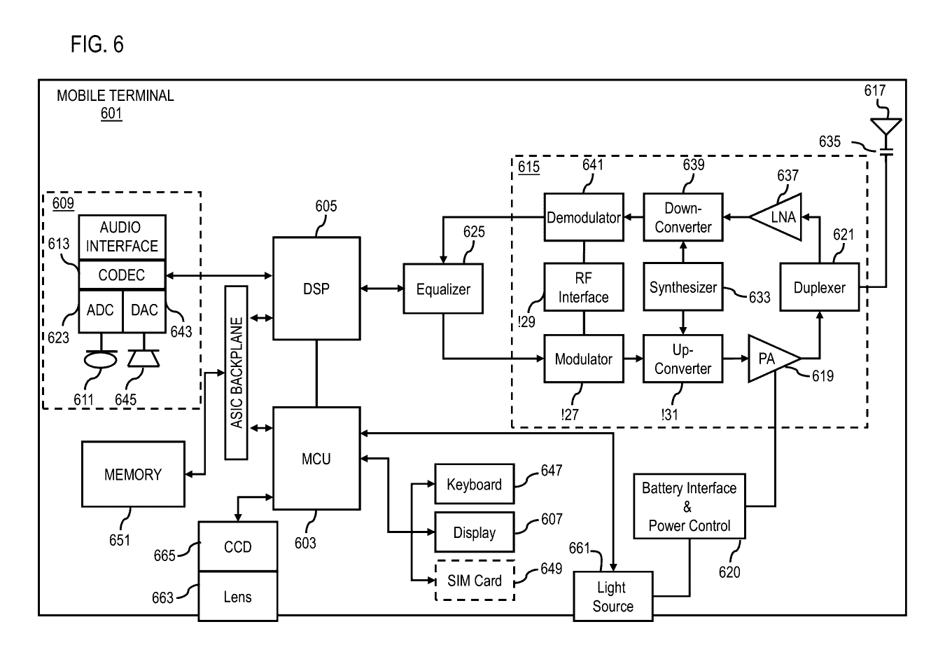

In an embodiment, the supplemental device 112 also includes a communication device 220 that transmits a theft alert signal including the current location data, in the event that the electrical device 110 is removed from the predetermined location 114. In an example embodiment, a searching entity, such as a leasing agency or insurance agency, or law enforcement entity at a remote receiver 250 receives the theft alert signal including the current location data signal, in an effort to recover the electrical device 110. In another embodiment, the communication device 220 captures usage data of the electrical device 110 and subsequently transmits a signal including the usage data to the remote receiver 250. In various embodiments, the communication device 220 comprises a mobile terminal, as depicted in FIG. 6.

### 2. Example Embodiments

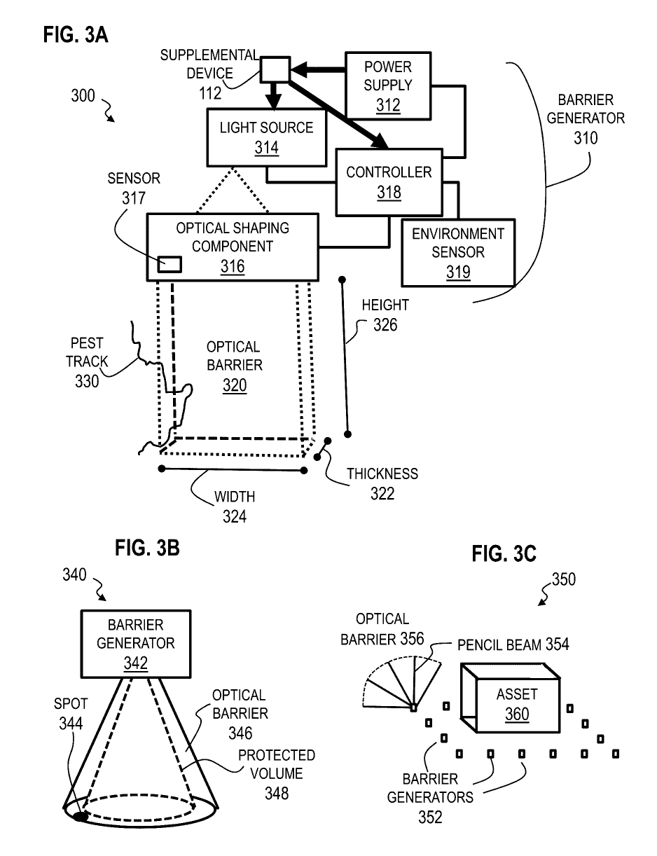

FIG. 3A is a block diagram that illustrates a system 300 for generating an optical barrier 320 to pests and integrated supplemental device 112, according to one embodiment. The proposed system does not contribute to the chemical or biological load on humans and the environment. This new method practiced by this apparatus provides defense in two or more dimensions for a community, in contrast to traditional approaches requiring physical contact between chemical agents and mosquitoes. The illustrated embodiment does not require cumbersome physical barriers; and eliminates pitfalls related to human negligence during daily installation of nets and inadequate coverage of chemical treatments. The protected volume can be easily and permanently sized for children, thus no adults can re-use the children's devices for their own purpose. In some embodiments, the barrier provides visual feedback on the state of protection by default; therefore no expertise is necessary to evaluate the operational status of the equipment. In some embodiments, where infrared or other light not visible to humans is used, an additional light is added to the device that provides visual feedback of correct orientation and operation.

System 300 includes a barrier generator 310 that produces an optical barrier 320 at least intermittently. In the illustrated embodiment, the barrier generator 310 includes a power supply 312, a light source 314, optical shaping component 316, controller 318 and environment sensor 319. In some embodiments, one or more components of generator 310 are omitted, or additional components are added. For example, in some embodiments, the environment sensor 319 is omitted and the generator is operated by the controller 318 independently of environmental conditions. In some embodiments, the generator 310 has a simple single configuration and the controller 318 is also omitted. In some embodiments, the light source 314 output is suitable for the barrier and the optical shaping component 316 is omitted.

The power supply 312 is any power supply known in the art that can provide sufficient power to the light source 314 that the light intensity in the optical barrier is enough to perturb pests, e.g., about one Watts per square centimeter (cm, 1 cm=10⁻² meters). As depicted in FIG. 3A, the supplemental device 112 is positioned between the power supply 312 and the light source 314 or controller 318 or both, such that one side of the switch 212 (FIG. 2) is connected to the power supply 312 and the other side of the switch 212 is connected to the light source 314 or controller 318 or both. If the barrier generator 310 is removed from the predetermined location 114 (FIG. 1), the switch 212 of the supplemental device 112 is turned “off”, which cuts off power between the power supply 312 and the light source 314 or controller 318 or both, thereby rendering the barrier generator 310 inoperable. Although FIG. 3A depicts that the supplemental device 112 cuts off power between the power supply 312 and the light source 314 when the barrier generator 310 is removed from the predetermined location 114, this is merely one of several examples of interventions to disable the functionality of the barrier generator 310.

In an example embodiment, the power supply is an outlet from a municipal power grid with a transformer and rectifier to output a direct current voltage of 2.86 Volts and currents between about one and about 60 Amperes. For example, an Agilent 6671A J08-DC Laboratory Power Supply (0-3V, 0-300 A) manufactured by Agilent Technologies, Inc., 5301 Stevens Creek Blvd., Santa Clara Calif., is used. Any DC power supply providing sufficient voltage, current, and stability to drive the light source is used in other embodiments. In various other embodiments, the power supply is a battery, a solar cell, a hydroelectric generator, a wind driven generator, a geothermal generator, or some other source of local power.

In some embodiments, the light source 314 is any source of one or more continuous or pulsed optical wavelengths, such as a laser, laser diode, light emitting diode, lightbulb, flashtube, fluorescent bulbs, incandescent bulbs, sunlight, gas discharge, combustion-based, or electrical arcs. In an example embodiment, laser or light emitting diode sources in the infrared region include but are not limited to 808 nanometer (nm), 1350 nm, 1550 nm emitters. In other embodiments, while the light source of the barrier can be any kind of regular light source, laser light sources are expected to be more suitable due to the increased abruptness and controlled dispersion of laser sources (making it easier to focus laser beams towards the desired portion of space). In an embodiment, a scanning beam is often easier to accomplish using laser beams. In an example embodiment, the light source 314 is a laser diode emitting a near infrared (NIR) wavelength of 808 nm in a beam with a total power of two Watts. The optical beam produced by this laser experiences dispersion characterized by an angular spread of about +/−10 degrees in one direction and +/−30 degrees in a perpendicular direction.

The optical shaping component 316 includes one or more optical couplers for affecting the location, size, shape, intensity profile, pulse profile, spectral profile or duration of an optical barrier. In some embodiments, an optical coupler is any combination of components known in the art that are used to direct and control an optical beam, such as free space, vacuum, lenses, mirrors, beam splitters, wave plates, optical fibers, shutters, apertures, linear and nonlinear optical elements, circulators, parabolic concentrators, Fresnel lenses and any other devices and methods that are used to control light. An example embodiment of a Fresnel lens is available from Knight Optical (USA) LLC, 1130 Ten Rod Road, Suite D102, North Kingstown, R.I. 02852. An example embodiment of a parabolic concentrator is available from Edmund Optics Inc., 101 East Gloucester Pike, Barrington, N.J. 08007-1380 USA. In some embodiments, the optical shaping component includes one or more controllable devices for changing the frequency, shape, duration or power of an optical beam, such as an acousto-optical modulator (AOM), a Faraday isolator, a Pockels cell, an electro-optical modulator (EOM), a magneto-optic modulator (MOM), an amplifier, a moving mirror/lens, a controlled shape mirror/lens, a shutter, and an iris, among others. For example, an experimental embodiment of the optical shaping component 316 includes an anti-reflection (AR) coated collimating lens (to turn the diverging beam from the laser into a substantively parallel beam) and a shutter to alternately block and pass the parallel beam. Several manufacturers supply such optical components include Thorlabs, of Newton, N.J.; New Focus, of Santa Clara, Calif.; Edmund Optics Inc., of Barrington, N.J.; Anchor Optics of Barrington, N.J.; CVI Melles Griot of Albuquerque, N. Mex.; Newport Corporation of Irvine, Calif., among others.

In some embodiments, one or more of these optical elements are operated to cause an optical beam to be swept through a portion of space, such as rotating a multifaceted mirror to cause an optical beam to scan across a surface. In some embodiments, the optical shaping component 316 includes one or more sensors 317 to detect the operational performance of one or more optical couplers or optical devices of the component 316, such as light detector to determine the characteristics of the optical beam traversing the component 316 or portions thereof or a motion detector to determine whether moving parts, if any, are performing properly. In an embodiment, any sensors known in the art may be used, such as a photocell, a bolometer, a thermocouple, temperature sensors, a pyro-electric sensor, a photo-transistor, a photo-resistor, a light emitting diode, a photodiode, a charge coupled device (CCD), a CMOS sensor, or a one or two dimensional array of CCDs or CMOS sensors or temperature sensors. In some embodiments, one or more of the optical components are provided by one or more micro-electrical-mechanical systems (MEMS).

The controller 318 controls operation of at least one of the power supply 312 or the light sources 314 or the optical shaping component 316. For example, the controller 318 changes the power output of the power supply 312 to provide additional power when the barrier is to be on, and to conserve power when the barrier is to be off, e.g., according to a preset schedule or external input. In some embodiments, the controller receives data from one or more sensors 317 in the component 316, or environment sensor 319, and adjusts one or more controlling commands to the power supply 312, light source 314 or device of the component 316 in response to the output from the sensors. In an example embodiment, instead of cutting off power between the power supply 312 and the light source 314 upon removal of the barrier generator 310 from the predetermined location 114, the supplemental device 112 may alternately disrupt data flow between the controller 318 and one or more of the sensors 317, 319, to disable operation of the barrier generator 310. In some embodiments one or more feedback loops, interlocks, motion sensors, temperature sensors, light sensors are used, alone or in some combination. In some embodiments, the controller can be used to choose between different setups which define controlling schemes between different operation modes based on the input from the sensors or any input from the user. In some embodiments, the controller is used to drive any other devices which are synchronized with the optical barrier generator. Any device known in the art may be used as the controller, such as special purpose hardware like an application specific integrated circuit (ASIC) or a general purpose computer as depicted in FIG. 4 or a programmable chip set as depicted in FIG. 5, all described in more detail in a later section.

The environment sensor 319 detects one or more environmental conditions, such as ambient light for one or more wavelengths or wavelength ranges or in one or more directions, ambient noise for one or more acoustic frequencies or directions, temperature, temperature gradients in one or more directions, humidity, pressure, wind, chemical composition of air, movement of the ground or the environment, vibration, dust, fog, electric charge, magnetic fields or rainfall, among others, alone or in some combination. Any environment sensor known in the art may be used. There are a huge number of sensor vendors, including OMEGA Engineering of Stamford, Conn. In some embodiments, the environment sensor 319 is omitted. In embodiments that include the environment sensor 319, the controller 318 uses data from the environment sensor 319 to control the operation of one or more of the power supply 312, light source 314 or shaping component 316. For example, in some embodiments under conditions of high ambient light, light intensity output by the source 314 or component 316 is increased. As another example, in some embodiments under conditions of near 100% ambient humidity, optical shaping component 316 is adapted to reshape a beam to compensate for increased scattering.

In at least some states (e.g., during a scheduled period or in response to a value output by the environment sensor 319 falling within a predetermined range) the barrier generator 310 produces an optical barrier 320. The optical barrier 320 comprises an optical waveform of sufficient power to perturb a pest and extends in a portion of space related to the generator 310. In some embodiments, the power of the waveform in the portion of space is limited by a maximum power, such as a maximum safe power for the one or more wavelengths of the optical waveform. For example, the illustrated optical barrier occupies a portion of space below the generator. The portion of space can be described as a thin sheet of height 326, width 324 and thickness 322, where thickness 322 represents the narrowest dimension of the barrier 320. Outside the optical barrier 320, the optical waveform, if present, is not sufficiently strong to adequately perturb a pest. In some embodiments, the optical barrier 320 is confined in one or more dimensions by walls or floor of a solid structure, or some combination. In some embodiments, the thin sheet barrier 320 is configured to cover an opening in a wall, such as a door or window.

Effective perturbation of a pest is illustrated in FIG. 3A as causing a pest to travel a pest track 330 that turns back rather than crosses the optical barrier 320. In some embodiments, effective perturbation of a pest includes immobilizing the pest or disabling or killing a living pest. Thus, the optical barrier generator 310 is configured to emit light of an optical waveform above a threshold power in a portion of space positioned relative to the generator 310, wherein the particular optical waveform above the threshold power is effective at perturbing a pest to human activity. In some embodiments, pest perturbation is not observed in normal sunlight, which corresponds to visible light at power density levels below about 30 milliWatts per square centimeter, i.e., less than about 0.03 Watts per square centimeter (W/cm²). In these embodiments, pest perturbations were observed at power density levels above about 1 W/cm².

In various other embodiments, the optical barrier occupies different portions of space relative to the generator, too numerous to illustrate. However, FIG. 3B and FIG. 3C depict two alternative portions of space to be occupied by optical barriers. FIG. 3B is a diagram that illustrates an example optical barrier 346 and integrated supplemental device, according to another embodiment. A hollow conical optical barrier 346 is generated below barrier generator 342 and surrounds conical protected volume 348. As with the barrier generator 310 of FIG. 3A, the supplemental device 112 is provided between the power supply (not shown) and light source (not shown) of the barrier generator 342. If the barrier generator 342 is removed from the predetermined location 114, the switch 212 of the supplemental device 112 is turned “off” to cut off power between the power supply and light source of the barrier generator 342, thereby rendering the barrier generator 342 inoperable. In some of these embodiments, the optical barrier 346 is produced by causing a narrow optical beam that produces an individual spot, such as spot 344, to sweep along a circular track on a horizontal surface below the barrier generator. The circular track is desirably circumscribed in a time short compared to the transit time of a pest through the beam that produces the spot 344.

FIG. 3C is a diagram that illustrates an example optical barrier 356 and integrated supplemental device, according to still another embodiment. In the illustrated embodiment, multiple barrier generators 352 surround an asset 360, such as a person, or a fixed asset such as a loading dock or pier, or a temporarily fixed asset such as a tent where one or more persons reside. Each barrier generator 352 generates a fan shaped optical barrier 356. As with the barrier generator 310 of FIG. 3A, the supplemental device 112 is provided between the power supply (not shown) and light source (not shown) of each barrier generator 352. If a barrier generator 352 is removed from the predetermined location 114, the switch 212 of the supplemental device 112 is turned “off” to cut off power between the power supply and light source of the barrier generator 352, thereby rendering the barrier generator 352 inoperable.

In the illustrated embodiment, each optical barrier 356 is a thin fan that covers an obtuse angle of about 320 degrees in one plane and sufficiently thick in a perpendicular plane (not shown) to perturb a pest. The distance of an outer edge of the barrier 356, e.g., an edge farthest from the barrier generator 352, is determined by attenuation or spreading of the light beam forming the barrier 356. In some embodiments, the optical barrier 356 is produced by causing a narrow optical beam, e.g., pencil beam 354, to sweep through the angular range about the barrier generator 352. The sweep is desirably completed in a time short compared to the transit time of a pest through the beam 354. The barrier generators 352 are spaced so that the fan shaped barrier of one generator 352 covers some or all of the space not covered by a fan of an adjacent barrier generator 352 to perturb pests that might otherwise reach asset 360.

The wavelength of the light creating the barrier is selected based on various factors. The cost of the device creating the light barrier can depend on the wavelength(s) of the light barrier. It is cost effective to select a set of one or more wavelengths that are produced by low cost, mass produced devices, such as light emitting diodes (LEDs). The effect on pests depends on the wavelength(s), e.g. the heat sensors of different animals can be more affected by near infrared (NIR) or infrared (IR) light than by visible light. The absorption, scattering, reflection, refraction, interference and diffraction of light from the light barrier by the eyes of animals or by one or more drops of liquids depend upon wavelength. The combination of different wavelengths can have special effects (e.g., synergistic or conflicting effects) or combined effects on pests. The wavelength also affects safety considerations for humans, or the appropriate animals or other objects not to be harmed in the vicinity of the barrier.

According to the points mentioned above, the light barrier's wavelength(s) is/are determined so that (i) the barrier has sufficient effect on a pest, (ii) the generator is affordable, (iii) the power consumption of the generator is sustainable for a particular purpose, (iv) the lifetime of the generator is sufficiently long to be useful, (v) an abrupt change in light is experienced upon entering the barrier, and, (vi) the barrier is safe for humans if operated in the vicinity of humans. For all these reasons, in an illustrated embodiment a near infrared (NIR) wavelength is used. In one example embodiment, the wavelength range above 1400 nanometers (nm, 1 nm=10⁻⁹ meters) is used because the human safety limits are much less restrictive above than below that wavelength. In another example embodiment, a wavelength range between about 1500 nm to about 1800 nm is used, where the human safety limits are the least restrictive. In an example embodiment, a NIR wavelength range of 800-870 nm is used.

Effective optical barriers have been obtained at about 800 nm for experimental embodiments, and one or more wavelengths in a range centered about 800 nm are used in some embodiments. In some of these embodiments, considered more dangerous to human users, the optical waveform includes a continuous or pulsing beam in the visible range, e.g., red (about 700 nm) to warn the human users of the presence of a possibly dangerous optical barrier. In some respects, the performance of near infrared (NIR) wavelengths, where safety limits are more relaxed, is forecast by experiments performed with cost effective, shorter NIR wavelengths, where the safety limits are tighter. In various embodiments, the performance of safe near infrared (NIR) wavelengths is forecast by experiments performed with other cost effective IR or visible wavelengths.

In an illustrated embodiment, the optical barrier is used in order to make it harder for arthropods to enter a given volume and potentially attack or feed on humans (or other animals or food products) inside, while keeping the device safe for use, e.g., safe for humans or other large animals to cross or enter the barrier and suffer no substantial negative effect. It is an advantage to use optical (e.g., visible, far infrared, FIR, NIR or IR) wavelengths for this purpose, especially the IR wavelength band. Many blood feeding animals, e.g. mosquitoes, detect humans using a combination of different sensors, including heat sensors and their eyes. FIR, NIR or IR affects heat sensors directly, while such wavelengths can also heat up the bodies of the usually dark-skinned animals with such sensors. For humans, the part of the body to be protected which is most sensitive to light is the eye. Visible light is focused onto the retina, and therefore collected on a small surface. Light with larger wavelength behaves differently: it does not get focused on the retina, but somewhere closer to the surface of the eye, e.g. on the cornea. If the focal length is too small, the light is collected on a thin surface layer to which it can be harmful. A more desirable scenario is when the light gets absorbed by the bulk of the eye; therefore the optical beam's heat is spread over a larger volume, having much less effect than in other cases where the beam's energy is focused or collects on a surface. The NIR wavelengths are expected to be more useful that ultraviolet or purely visible light for the application of defending humans from arthropods. Mosquitoes are also expected to sense at least some IR wavelengths, even though human eyes do not detect such wavelengths.

Light absorption in materials depends upon wavelength. Visible light does not get absorbed in the cornea or lens, and therefore it can reach the retina in both human and mosquito eyes (where the retina consists of only a few retinula cells). IR light gets absorbed quicker. For certain wavelength ranges, this absorption is really quick and the surface layers of the eye absorb all the light, therefore strong illumination can burn the eye's surface. For the human eye, there is an optimal peculiar wavelength band centered about 1550 nm. This advantageous wavelength range is also reflected in the international laser safety standards, where this wavelength interval has much higher threshold than other wavelengths. Being much smaller than the human eye, the above mentioned wavelength penetrates the mosquito eye and reaches the retinula cells; therefore the mosquito's eye's sensitivity is expected to be greater than the sensitivity of the human eye in the NIR band around 1550 nm.

In some embodiments, the barrier helps to mitigate various vector borne diseases, such as malaria, in the established and developing world. The barrier generator provides such mitigation without directly damaging the environment with chemicals or biological agents. The barrier generator is difficult to misuse or hijack for other purposes, such as using mosquito nets for fishing in developing countries. In some embodiments, the barrier generator also provides a solution in developed countries, e.g., by being mounted above beds or in windows or doorways to keep mosquitoes or other insects away from humans or mounting barrier generators to protect entrances to transportation equipment such as planes, ships, trains, among others, which are capable of carrying pests to other geographic areas, potentially far away from their original habitat.

For determining the power range of the optical barrier, one needs to consider the aspects described for choosing the wavelength of the barrier. The effect on different animals, the cost, the effect on humans, etc. also largely depends on the power range. An effective power level can be determined through routine experimentation. In the experiments described in more detail below power level of about four Watts/cm² is effective at perturbing the behavior of both mosquitoes and fruit flies and likely other insects. In general, a power range from more than about one up to less than many Watts/cm² is considered effective and made safe.

In various embodiments, the barrier is generated to have different shapes, depending on the application. It can be an optical slab, or wall, with cone, plane, disk, pyramid, or other, arbitrary shapes, as shown in FIG. 3B and FIG. 3C, above. The barrier can cover an area, a dwelling, a warehouse, a plaza, a road, a pier, bodies of water, etc. For the application of keeping arthropods away from humans, in various embodiments, one or more barriers are placed in windows, below the ceiling/roof, over the bed, in doors, on the ceiling, over a table or chair, over a house or tent, at other openings of houses, buildings, bunkers, fortified locations, at the windows, doors or other openings of transportation vehicles (aircrafts, cars, trucks, ships, boats, trains, among others), or a person can carry the barrier generator, alone or in some combination.

In various embodiments, the barrier is made of light with various temporal properties. In various embodiments, the light is quasi continuous, continuous or pulsed, or some combination. Besides having the barrier turned on or off as a whole, such as in a stationary wall, one can use alternative embodiments, e.g. a scanning beam that scans through the barrier in some function of time. For example if a laser beam scans through a plane with high enough scan frequency, an arthropod attempting to cross the barrier will be illuminated by the light independently of its path or velocity. In some application, this solution is preferable over a stationary barrier, e.g. if a short but intense illumination has more effect than a longer but less intense one. Thus a waveform includes stationary or scanning light of one or more wavelengths of varying intensity, duration and direction.

In some embodiments, light is also targeted using some feedback based on the surrounding environment of the barrier generator. For example, the barrier turns on only when some motion (or other) sensors detect an arthropod attempting to cross the barrier. In some embodiments the time when the barrier is on is restricted to when a human enters the protected volume, or to dusk and dawn when some blood feeding arthropods are the most active. Some of these embodiments significantly decrease power consumption or differentiate between different animals and different types of crossings.

In some embodiments, the optical barrier is used to differentially affect animals with different properties or characteristics. For example, the optical barrier is used to differentially affect animals: large vs. small, light vs. dark, fast vs. slow, charged vs. neutral, sharp vs. smooth, different materials, different densities, different directions of motion, different sensitivities, night vs. dark adapted, female vs. male, old vs. young, among others.

In one embodiment, the supplemental device 112 temporarily disables operation of the electrical device 110 until the electrical device 110 is returned to the predetermined location 114. In this embodiment, the processor 214 (FIG. 2) compares the current location data of the electrical device from the tracker chip 210 with the stored predetermined location 114 from the memory chip 216. Once the processor 214 (FIG. 2) determines that the current location data from the tracker chip 210 is outside the predetermined location 114 from the memory chip 216, the processor 214 transmits a signal to the switch 212 to turn the switch to the “off” position and temporarily disable the electrical device 110. After the electrical device 110 is returned to the predetermined location 114 and the processor 214 determines that the current location data from the tracker chip 210 is within the stored predetermined location 114 from the memory chip 216, the processor 214 transmits a signal to the switch to turn the switch back to the “on” position and electrical power is delivered from the power supply 224 to the circuitry of the electrical device 110.

In another embodiment, the supplemental device 112 permanently disables operation of the electrical device 110 upon removal of the electrical device 110 from the predetermined location 114. In this embodiment, once the processor 214 determines that the current location data from the tracker chip 210 is outside the predetermined location 114 stored in the memory chip 216, the processor 214 transmits a signal to the switch 212 to permanently turn the switch to the “off” position and thus permanently cut off electrical power between the power supply 224 and the circuitry 222 of the electrical device 110.

In an embodiment, the electrical device 110 is deployed outdoors, such as a solar power system that is remotely activated. Theft and resale of such outdoor electrical devices is a problem, particularly where such electrical devices are leased or donated to the user of the electrical device. For example, such outdoor electrical devices are subsidized or donated by charities or other organizations to low income households in developing nations. These outdoor electrical devices are frequently stolen by outside entities or sold by the user to outside entities for short-term profit. Less affluent households in many developing nations experience difficulties with deploying solar cells and connected electric devices. Since a solar cell is placed outside of the house (e.g. on the roof) it is easily removable by outside entities. It is also possible that the user sells graciously donated solar cells to outside entities for short term personal gain. It is also possible that the user sells subsidized products at a non-subsidized market for gain. As solar cells are still very expensive relative to the income of many households that would need to use them, their high value and easy removability makes them a prime target to theft and/or unauthorized sales.

In an embodiment, the electrical device 110 is a solar power system that includes a solar panel or solar cell. In one embodiment, where the electrical device 110 is a solar cell, one side of the switch 212 is connected to a p-n junction in the solar cell made of silicon (power supply 224) and the other side of the switch 212 is connected to electrodes of the solar cell (circuitry 222). When the processor 214 determines that the current solar cell location (from tracker chip 210) is outside the intended location 116 (from memory chip 216), the processor 214 turns the switch 212 to “off” position. This cuts off connection between the p-n junction and electrodes of the solar cell and thus disables operation of the solar cell.

The embodiment of the electrical device 110 advantageously permits low-risk leasing of solar power systems to low income households. Leasing of lighting and other devices would be greatly facilitated if the removal of the devices would not be possible from the house where they are deployed, thereby eliminating most risk factors. In one embodiment, the leasing of such electrical devices 110 could be for the price that these households pay for lighting (e.g. kerosene) monthly until the price of the solar power system and associated financing is repaid. Various advantages of this embodiment include short-term profit for the solar power system provider, an increased customer base, higher long-term gain to the household than alternative lighting methods and higher educational opportunities to the families in developing nations by providing lighting after dark.

In another embodiment, the solar power system may be locally activated via a cryptographic code or other secure means. In another embodiment, the electrical device 110 is used indoors, such as a television set or a computer or any household appliance. In this example embodiment, a user can set up the electrical device 110 (e.g. television) after placing it in the house such that if it is removed from the house, it will not be usable unless it is reset by using a password or a specialized device. This feature advantageously protects the leaser, the lease provider, the user, the owner, and insurance companies.

In an embodiment, to modify the stored intended location 116, distance range 118 and/or a time period for a solar cell device when the prepaid rental is active, a modified intended location 116, distance range 118 and/or time period needs to be re-entered into the encoding chip 218 using the secure encrypted format. In one embodiment, the modified intended location 116, distance range 118 and/or time period needs to be re-entered by law enforcement authorities.

In an embodiment, the intended location 116 can be trivially programmed into the supplemental device 112 (e.g. encoding chip 218) at installation and it is impossible to reprogram the intended location 116 without encryption keys, specialized equipment, or in general by anybody else but the authorized provider. In one embodiment, initial setup is simple, e.g. by simply pressing a button or removing a seal, etc. on a not-yet-used electrical device 110. After this, the electrical device 110 location cannot be changed by, e.g., a thief or a customer of the device without disrupting the functionality of the electrical device 110.

In an embodiment, the current location data signal transmitted by the communication device 220 is used to localize the position of the electrical device 110 to within a precision of a few meters, to assist in recovery of the electrical device 100 by authorities. In an example embodiment, the current location data signal need only localize the position of the electrical device 110 to within a precise of a few kilometers (kms), for purposes of distinguishing between countries, regions or continents.

In an example embodiment, the communication device 220 communicates with a cellular phone using widespread technologies, such as Google Valet® or ANT+Sensor®, for example. In some embodiments, even if the cell phone is unable to communicate with the communication device 220 directly, the communication device 220 can capture its signal that it sends to a remote location and retrieve information from the signal. In still other embodiments, the electrical device 110 can incorporate its own long-distance communication apparatus if necessary and if its cost is acceptable for the application. In an example embodiment, the communication device 220 can also communicate subscription status and credit refills. In another example embodiment, a camera captures one or more images of a theft suspect after the electrical device 110 is removed from the predetermined location 114. The camera transmits the images to the communication device 220, which subsequently transmits the images and the current location data to a law enforcement entity, in an effort to apprehend the theft suspect.

In one embodiment, the predetermined location 114 is a geographic territory, such as a village. In this embodiment, if the device 110 is stolen but kept within the village (as it cannot be used elsewhere), the user can track the device 110 and find it within the village through the communication device 220. In another embodiment, the distance range 118 is at least 100 meters.

In another embodiment, the predetermined location 114 comprises a plurality of separated locations, where each separated location is a permitted region of use of the electrical device 110. In an example embodiment, a first location is a primary residence of a user of the electrical device 110 and a second location is a travel residence of the user of the electrical device 110. In another embodiment, the predetermined location 114 comprises a plurality of locations, such as one or more continuous locations along a predetermined track or a path. For example, the predetermined location 114 comprises a predetermined shipment track for the electrical device 110. In the event that current location data of the electrical device 110 deviates from the predetermined shipment track or a shipment schedule of the electrical device 110 along the predetermined shipment track is not maintained, the supplemental device 112 is configured to disable operation of the electrical device 110. In this embodiment, the electrical device 110 is transported along the predetermined shipment track using the shipment schedule with a vehicle, such as a land vehicle or air vehicle, such as a drone.

In one embodiment, the tracker chip 210 is a Global Positioning System (GPS) tracker chip that receives GPS location data indicative of the current location of the electrical device 110. In another embodiment, the tracker chip 210 is configured to capture a signal from a cellular phone located within the predetermined location 114, to acquire the current location data from the captured signal. In another embodiment, the tracker chip 210 communicates with local securely encoded transmitters to receive the current location data. In an example embodiment, local securely encoded transmitters can be used instead of GPS to ensure that costly equipment is not removed from areas where GPS is not available (e.g. buildings or mines). In an example embodiment, accelerometers or compasses can be used to track motion and sense if the electrical device 110 has moved and combined with direction data, a new location of the electrical device 110 is derived without using new GPS location data.

In another embodiment, instead of receiving the current location data from the tracker chip 210, the processor 214 derives the current location data based on data received from the tracker chip 210. In another embodiment, the encoding chip 218 includes one or more embedded, removable, or rechargeable chips.

In one embodiment, during initial setup of the system 100, the new electrical device 110 is brought to the predetermined location 114. A user then performs a simple operation, such as pushing a button or removing a seal on the electrical device 110, which causes the current location data (i.e. predetermined location 114) to be stored in the memory chip 216. In this embodiment, if the user moves outside of the predetermined location 114, the user would need to contact an outside entity, such as the manufacturer of the electrical device 110, to store the new predetermined location 114 in the memory chip 216.

In one embodiment, the predetermined location 114 defines an area where use of the electrical device 110 is prohibited. In this embodiment, in the event that the electrical device 110 is positioned within the predetermined location 114, the supplemental device 112 is configured to disable operation of the electrical device 110. Additionally, in this embodiment, when the electrical device 110 is positioned outside of the predetermined location 114, the supplemental device 112 takes no action such that use of the electrical device 110 is permitted.

In one embodiment, various measures can be taken to disable functionality of the electrical device 110 other than disconnecting the power supply 224 from the circuitry 222. For example, cutting output of the electrical device 110; cutting solar tracking for solar tracker devices; cutting a display or interface of the electrical interface 110; refusing operation of a processor of the electrical device 110; rendering a light output of the electrical device 110 inoperable; and rendering mosquito sensing of an optical barrier inoperable.

In one embodiment, the supplemental device 112 receives electrical power from the power supply 224 of the electrical device 110, and is a sufficiently small amount of electrical power so not to interfere with operation of the electrical device 110. In some embodiments, the supplemental device 112 need not receive electrical power at all times and only needs to receive electrical power when a user intends to use the electrical device 110, at which time the supplemental device 112 is configured to reboot and either enable or disable usage of the electrical device 110.

In one embodiment, the communication device 220 transmits the signal including the usage data to the remote location 250 that collects usage data from one or more electrical devices in a village. For example the remote location 250 is a specialized vehicle that collects the usage data from the electrical devices in the village by simply driving through the village. In an example embodiment, the collected usage data can also flow through a cell phone network or transmitted to a satellite. In this embodiment, the collected usage data could be used for research/survey, billing and safety purposes. In some embodiments, the communication device 220 sends usage information and receives possible instructions on operation of the electrical device 110. In an example embodiment, this feature is used when the device 110 is leased from a provider and the user needs to periodically re-enable it, e.g., after a monthly subscription fee is paid or prepaid options are obtained. In an example embodiment, this feature can be similar to costing structures for cell phones, which are popular in villages where people work many kilometers from any provider.

In an embodiment, the supplemental device 112 disables operation of the electrical device 110 based on factors other than (or in addition to) the current location of the electrical device 110. In an embodiment, the supplemental device 112 disables operation of the electrical device 110 as a function of time. In an example embodiment, the supplemental device 112 disables operation of the electrical device 110 during certain times of the day. In an example embodiment, the supplemental device 112 can be configured such that the electrical device 110 can charge cell phones and lighting devices only at certain times of the day. In another example embodiment, the supplemental device 112 can be configured such that the electrical device 110 can only be used after sunset, e.g. to save electricity or to encourage certain activities such as reading after sunset.

In another example embodiment, the supplemental device 112 limits operation of the electrical device 110 to specific secondary electrical devices and disables operation of the electrical device 110 if other secondary electrical devices are used with the electrical device 110. In an example embodiment, a solar cell with the supplemental device 112 can be set up such that the solar cell is only usable to supply a specific lighting device, or a cellphone charger, etc.

### 3. Processing Hardware Overview

FIG. 4 is a block diagram that illustrates a computer system 400 upon which an embodiment of the invention may be implemented. Computer system 400 includes a communication mechanism such as a bus 410 for passing information between other internal and external components of the computer system 400. Information is represented as physical signals of a measurable phenomenon, typically electric voltages, but including, in other embodiments, such phenomena as magnetic, electromagnetic, pressure, chemical, molecular atomic and quantum interactions. For example, north and south magnetic fields, or a zero and non-zero electric voltage, represent two states (0, 1) of a binary digit (bit).). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 400, or a portion thereof, constitutes a means for performing one or more steps of one or more methods described herein.

A sequence of binary digits constitutes digital data that is used to represent a number or code for a character. A bus 410 includes many parallel conductors of information so that information is transferred quickly among devices coupled to the bus 410. One or more processors 402 for processing information are coupled with the bus 410. A processor 402 performs a set of operations on information. The set of operations include bringing information in from the bus 410 and placing information on the bus 410. The set of operations also typically include comparing two or more units of information, shifting positions of units of information, and combining two or more units of information, such as by addition or multiplication. A sequence of operations to be executed by the processor 402 constitutes computer instructions.

Computer system 400 also includes a memory 404 coupled to bus 410. The memory 404, such as a random access memory (RAM) or other dynamic storage device, stores information including computer instructions. Dynamic memory allows information stored therein to be changed by the computer system 400. RAM allows a unit of information stored at a location called a memory address to be stored and retrieved independently of information at neighboring addresses. The memory 404 is also used by the processor 402 to store temporary values during execution of computer instructions. The computer system 400 also includes a read only memory (ROM) 406 or other static storage device coupled to the bus 410 for storing static information, including instructions, that is not changed by the computer system 400. Also coupled to bus 410 is a non-volatile (persistent) storage device 408, such as a magnetic disk or optical disk, for storing information, including instructions, that persists even when the computer system 400 is turned off or otherwise loses power.

Information, including instructions, is provided to the bus 410 for use by the processor from an external input device 412, such as a keyboard containing alphanumeric keys operated by a human user, or a sensor. A sensor detects conditions in its vicinity and transforms those detections into signals compatible with the signals used to represent information in computer system 400. Other external devices coupled to bus 410, used primarily for interacting with humans, include a display device 414, such as a cathode ray tube (CRT) or a liquid crystal display (LCD), for presenting images, and a pointing device 416, such as a mouse or a trackball or cursor direction keys, for controlling a position of a small cursor image presented on the display 414 and issuing commands associated with graphical elements presented on the display 414.

In the illustrated embodiment, special purpose hardware, such as an application specific integrated circuit (IC) 420, is coupled to bus 410. The special purpose hardware is configured to perform operations not performed by processor 402 quickly enough for special purposes. Examples of application specific ICs include graphics accelerator cards for generating images for display 414, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 400 also includes one or more instances of a communications interface 470 coupled to bus 410. Communication interface 470 provides a two-way communication coupling to a variety of external devices that operate with their own processors, such as printers, scanners and external disks. In general the coupling is with a network link 478 that is connected to a local network 480 to which a variety of external devices with their own processors are connected. For example, communication interface 470 may be a parallel port or a serial port or a universal serial bus (USB) port on a personal computer. In some embodiments, communications interface 470 is an integrated services digital network (ISDN) card or a digital subscriber line (DSL) card or a telephone modem that provides an information communication connection to a corresponding type of telephone line. In some embodiments, a communication interface 470 is a cable modem that converts signals on bus 410 into signals for a communication connection over a coaxial cable or into optical signals for a communication connection over a fiber optic cable. As another example, communications interface 470 may be a local area network (LAN) card to provide a data communication connection to a compatible LAN, such as Ethernet. Wireless links may also be implemented. Carrier waves, such as acoustic waves and electromagnetic waves, including radio, optical and infrared waves travel through space without wires or cables. Signals include man-made variations in amplitude, frequency, phase, polarization or other physical properties of carrier waves. For wireless links, the communications interface 470 sends and receives electrical, acoustic or electromagnetic signals, including infrared and optical signals, that carry information streams, such as digital data.

The term computer-readable medium is used herein to refer to any medium that participates in providing information to processor 402, including instructions for execution. Such a medium may take many forms, including, but not limited to, non-volatile media, volatile media and transmission media. Non-volatile media include, for example, optical or magnetic disks, such as storage device 408. Volatile media include, for example, dynamic memory 404. Transmission media include, for example, coaxial cables, copper wire, fiber optic cables, and waves that travel through space without wires or cables, such as acoustic waves and electromagnetic waves, including radio, optical and infrared waves. The term computer-readable storage medium is used herein to refer to any medium that participates in providing information to processor 402, except for transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a carrier wave, or any other medium from which a computer can read. The term non-transitory computer-readable storage medium is used herein to refer to any medium that participates in providing information to processor 402, except for carrier waves and other signals.

Logic encoded in one or more tangible media includes one or both of processor instructions on a computer-readable storage media and special purpose hardware, such as ASIC *420.

Network link 478 typically provides information communication through one or more networks to other devices that use or process the information. For example, network link 478 may provide a connection through local network 480 to a host computer 482 or to equipment 484 operated by an Internet Service Provider (ISP). ISP equipment 484 in turn provides data communication services through the public, world-wide packet-switching communication network of networks now commonly referred to as the Internet 490. A computer called a server 492 connected to the Internet provides a service in response to information received over the Internet. For example, server 492 provides information representing video data for presentation at display 414.

The invention is related to the use of computer system 400 for implementing the techniques described herein. According to one embodiment of the invention, those techniques are performed by computer system 400 in response to processor 402 executing one or more sequences of one or more instructions contained in memory 404. Such instructions, also called software and program code, may be read into memory 404 from another computer-readable medium such as storage device 408. Execution of the sequences of instructions contained in memory 404 causes processor 402 to perform the method steps described herein. In alternative embodiments, hardware, such as application specific integrated circuit 420, may be used in place of or in combination with software to implement the invention. Thus, embodiments of the invention are not limited to any specific combination of hardware and software.

The signals transmitted over network link 478 and other networks through communications interface 470, carry information to and from computer system 400. Computer system 400 can send and receive information, including program code, through the networks 480, 490 among others, through network link 478 and communications interface 470. In an example using the Internet 490, a server 492 transmits program code for a particular application, requested by a message sent from computer 400, through Internet 490, ISP equipment 484, local network 480 and communications interface 470. The received code may be executed by processor 402 as it is received, or may be stored in storage device 408 or other non-volatile storage for later execution, or both. In this manner, computer system 400 may obtain application program code in the form of a signal on a carrier wave.

Various forms of computer readable media may be involved in carrying one or more sequence of instructions or data or both to processor 402 for execution. For example, instructions and data may initially be carried on a magnetic disk of a remote computer such as host 482. The remote computer loads the instructions and data into its dynamic memory and sends the instructions and data over a telephone line using a modem. A modem local to the computer system 400 receives the instructions and data on a telephone line and uses an infra-red transmitter to convert the instructions and data to a signal on an infra-red a carrier wave serving as the network link 478. An infrared detector serving as communications interface 470 receives the instructions and data carried in the infrared signal and places information representing the instructions and data onto bus 410. Bus 410 carries the information to memory 404 from which processor 402 retrieves and executes the instructions using some of the data sent with the instructions. The instructions and data received in memory 404 may optionally be stored on storage device 408, either before or after execution by the processor 402.

FIG. 5 illustrates a chip set 500 upon which an embodiment of the invention may be implemented. Chip set 500 is programmed to perform one or more steps of a method described herein and includes, for instance, the processor and memory components described with respect to FIG. 2 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 500, or a portion thereof, constitutes a means for performing one or more steps of a method described herein.

In one embodiment, the chip set 500 includes a communication mechanism such as a bus 501 for passing information among the components of the chip set 500. A processor 503 has connectivity to the bus 501 to execute instructions and process information stored in, for example, a memory 505. The processor 503 may include one or more processing cores with each core configured to perform independently. A multi-core processor enables multiprocessing within a single physical package. Examples of a multi-core processor include two, four, eight, or greater numbers of processing cores. Alternatively or in addition, the processor 503 may include one or more microprocessors configured in tandem via the bus 501 to enable independent execution of instructions, pipelining, and multithreading. The processor 503 may also be accompanied with one or more specialized components to perform certain processing functions and tasks such as one or more digital signal processors (DSP) 507, or one or more application-specific integrated circuits (ASIC) 509. A DSP 507 typically is configured to process real-world signals (e.g., sound) in real time independently of the processor 503. Similarly, an ASIC 509 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 503 and accompanying components have connectivity to the memory 505 via the bus 501. The memory 505 includes both dynamic memory (e.g., RAM, magnetic disk, writable optical disk, etc.) and static memory (e.g., ROM, CD-ROM, etc.) for storing executable instructions that when executed perform one or more steps of a method described herein. The memory 505 also stores the data associated with or generated by the execution of one or more steps of the methods described herein.

FIG. 6 is a diagram of exemplary components of a mobile terminal 600 (e.g., cell phone handset) for communications, which is capable of operating in the system of FIG. 2, according to one embodiment. In some embodiments, mobile terminal 601, or a portion thereof, constitutes a means for performing one or more steps described herein. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 603, a Digital Signal Processor (DSP) 605, and a receiver/transmitter unit including a microphone gain control unit and a speaker gain control unit. A main display unit 607 provides a display to the user in support of various applications and mobile terminal functions that perform or support the steps as described herein. The display 607 includes display circuitry configured to display at least a portion of a user interface of the mobile terminal (e.g., mobile telephone). Additionally, the display 607 and display circuitry are configured to facilitate user control of at least some functions of the mobile terminal. An audio function circuitry 609 includes a microphone 611 and microphone amplifier that amplifies the speech signal output from the microphone 611. The amplified speech signal output from the microphone 611 is fed to a coder/decoder (CODEC) 613.

A radio section 615 amplifies power and converts frequency in order to communicate with a base station, which is included in a mobile communication system, via antenna 617. The power amplifier (PA) 619 and the transmitter/modulation circuitry are operationally responsive to the MCU 603, with an output from the PA 619 coupled to the duplexer 621 or circulator or antenna switch, as known in the art. The PA 619 also couples to a battery interface and power control unit 620.

In use, a user of mobile terminal 601 speaks into the microphone 611 and his or her voice along with any detected background noise is converted into an analog voltage. The analog voltage is then converted into a digital signal through the Analog to Digital Converter (ADC) 623. The control unit 603 routes the digital signal into the DSP 605 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 625 for compensation of any frequency-dependent impairments that occur during transmission though the air such as phase and amplitude distortion. After equalizing the bit stream, the modulator 627 combines the signal with a RF signal generated in the RF interface 629. The modulator 627 generates a sine wave by way of frequency or phase modulation. In order to prepare the signal for transmission, an up-converter 631 combines the sine wave output from the modulator 627 with another sine wave generated by a synthesizer 633 to achieve the desired frequency of transmission. The signal is then sent through a PA 619 to increase the signal to an appropriate power level. In practical systems, the PA 619 acts as a variable gain amplifier whose gain is controlled by the DSP 605 from information received from a network base station. The signal is then filtered within the duplexer 621 and optionally sent to an antenna coupler 635 to match impedances to provide maximum power transfer. Finally, the signal is transmitted via antenna 617 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 601 are received via antenna 617 and immediately amplified by a low noise amplifier (LNA) 637. A down-converter 639 lowers the carrier frequency while the demodulator 641 strips away the RF leaving only a digital bit stream. The signal then goes through the equalizer 625 and is processed by the DSP 605. A Digital to Analog Converter (DAC) 643 converts the signal and the resulting output is transmitted to the user through the speaker 645, all under control of a Main Control Unit (MCU) 603 which can be implemented as a Central Processing Unit (CPU) (not shown).

The MCU 603 receives various signals including input signals from the keyboard 647. The keyboard 647 and/or the MCU 603 in combination with other user input components (e.g., the microphone 611) comprise a user interface circuitry for managing user input. The MCU 603 runs a user interface software to facilitate user control of at least some functions of the mobile terminal 601 as described herein. The MCU 603 also delivers a display command and a switch command to the display 607 and to the speech output switching controller, respectively. Further, the MCU 603 exchanges information with the DSP 605 and can access an optionally incorporated SIM card 649 and a memory 651. In addition, the MCU 603 executes various control functions required of the terminal. The DSP 605 may, depending upon the implementation, perform any of a variety of conventional digital processing functions on the voice signals. Additionally, DSP 605 determines the background noise level of the local environment from the signals detected by microphone 611 and sets the gain of microphone 611 to a level selected to compensate for the natural tendency of the user of the mobile terminal 601.

The CODEC 613 includes the ADC 623 and DAC 643. The memory 651 stores various data including call incoming tone data and is capable of storing other data including music data received via, e.g., the global Internet. The software module could reside in RAM memory, flash memory, registers, or any other form of writable storage medium known in the art. The memory device 651 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 649 carries, for instance, important information, such as the cellular phone number, the carrier supplying service, subscription details, and security information. The SIM card 649 serves primarily to identify the mobile terminal 601 on a radio network. The card 649 also contains a memory for storing a personal telephone number registry, text messages, and user specific mobile terminal settings.

In some embodiments, the mobile terminal 601 includes a digital camera comprising an array of optical detectors, such as charge coupled device (CCD) array 665. The output of the array is image data that is transferred to the MCU for further processing or storage in the memory 651 or both. In the illustrated embodiment, the light impinges on the optical array through a lens 663, such as a pin-hole lens or a material lens made of an optical grade glass or plastic material. In the illustrated embodiment, the mobile terminal 601 includes a light source 661, such as a LED to illuminate a subject for capture by the optical array, e.g., CCD 665. The light source is powered by the battery interface and power control module 620 and controlled by the MCU 603 based on instructions stored or loaded into the MCU 603.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense. Throughout this specification and the claims, unless the context requires otherwise, the word “comprise” and its variations, such as “comprises” and “comprising,” will be understood to imply the inclusion of a stated item, element or step or group of items, elements or steps but not the exclusion of any other item, element or step or group of items, elements or steps. Furthermore, the indefinite article “a” or “an” is meant to indicate one or more of the item, element or step modified by the article. As used herein, unless otherwise clear from the context, a value is “about” another value if it is within a factor of two (twice or half) of the other value. While example ranges are given, unless otherwise clear from the context, any contained ranges are also intended in various embodiments. Thus, a range from 0 to 10 includes the range 1 to 4 in some embodiments.

What is claimed is:

1. An apparatus comprising:
a switch with one side connected to a power supply of an electrical device and another side connected to circuitry of the electrical device;
a tracker chip to receive current location data of the electrical device;
at least one processor;
at least one memory chip including one or more sequences of instructions and a predetermined location of the electrical device; and
a secure encoding chip, wherein the predetermined location is input in the secure encoding chip in an encrypted format;
the at least one memory chip and the one or more sequences of instructions configured to, with the at least one processor, cause the processor to perform at least the following,
receive the current location data from the tracker chip,
compare the current location data with the predetermination location, and
turn off the switch to disconnect the power supply from the circuitry if the current location data does not correspond to the predetermined location.

2. The apparatus of claim 1, wherein the predetermined location comprises an intended location and a distance range from the intended location.

3. The apparatus of claim 1, wherein the predetermined location comprises a geographical territory.

4. The apparatus of claim 1, wherein the predetermined location comprises a plurality of separated locations.

5. The apparatus of claim 1, wherein the memory chip and the one or more sequences of instructions are configured to, with the at least one processor, cause the processor to turn on the switch and reconnect the power supply to the circuitry if the current location data corresponds to the predetermined location.

6. The apparatus of claim 1, wherein the tracker chip is a Global Positioning System (GPS) tracker chip to receive current GPS location data of the apparatus.

7. The apparatus of claim 1, wherein the tracker chip captures a signal including the current location data from a cellular phone at the predetermined location.

8. The apparatus of claim 1, further comprising a communication device configured to collect usage data of the electrical device and transmit the usage data to a remote location.

9. The apparatus of claim 1, further comprising a communication device configured to transmit a theft alert signal including the current location data to a remote location.

10. The apparatus of claim 1, wherein the memory chip and the one or more sequences of instructions are configured to, with the at least one processor, cause the processor to transmit a signal to a law enforcement entity with the current location data if the current location data does not correspond to the predetermined location.

11. A system comprising:
an electrical device comprising a power supply and circuitry; and
a supplemental device integrated into the electrical device, comprising;
a tracker chip to receive current location data of the electrical device,
a switch with one side connected to the power supply and another side connected to the circuitry of the electrical device;
at least one processor;
at least one memory chip including one or more sequences of instructions and a predetermined location of the electrical device; and
a secure encoding chip, wherein the predetermined location is input in the secure encoding chip in an encrypted format;
the at least one memory chip and the one or more sequences of instructions configured to, with the at least one processor, cause the processor to perform at least the following,
receive the current location data from the tracker chip,
compare the current location data with the predetermination location,
turn off the switch to disconnect the power supply from the circuitry if the current location data does not correspond to the predetermined location.

12. The system of claim 11, wherein the electrical device is a barrier generator that produces an optical barrier to pests and wherein the circuitry comprises a light source to generate the optical barrier.

13. The system of claim 11, wherein the electrical device is a solar cell.

14. The system of claim 11, wherein the electrical device is deployed outdoors.
